(19) United States
(12) Patent Application Publication
(10) Pub. No.: US 2004/0026111 A1
(43) Pub. Date: Feb. 12, 2004

(54) Coaxial cable and a manufacturing method

(76) Inventor: Martti Vuotilainen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/447,289

(22) Filed: May 29, 2003

Related U.S. Application Data
(63) Continuation of application No. PCT/FI02/00480, filed on Jun. 4, 2002.

(30) Foreign Application Priority Data
Jun. 4, 2002 (WO) PCT/FI02/00480

(51) Int. Cl. H01B 7/18

(52) U.S. Cl. 174/102 R

(57) ABSTRACT

The invention relates to a coaxial cable for transmitting signals, comprising an inner conductor (302), said inner conductor (302) comprising a conducting layer (400) for conducting a signal The conducting layer (400) of the inner conductor (302) has a thickness that depends on the skin factor of the highest frequency component contained in signals to be transmitted in the coaxial cable (300). The invention also relates to a method for manufacturing said coaxial cable.

### FIELD

The invention relates to coaxial cables and a method of manufacturing the same.

### BACKGROUND

Coaxial cables are widely used for instance in telecommunication networks for signal transmission. The coaxial structure can be considered as the optimal structure for electrical high-frequency signal transmission mediums, because of the symmetric structure. Symmetric structures are relatively easy to manufacture without defects, and currents are distributed cylinder-symmetrically on the surfaces of conductors. Thus, in the symmetric structure the density of the current is equal in a certain position and at a certain depth in the conducting material.

Coaxial cables, however, are subject to inter symbol interference because high-frequency and low-frequency components in the transmitted signal attenuate in a different way. The attenuation shown by equation (1) is inversely proportional to the conductivity of the conductor and the current conducting area A.

$$R = \frac{1}{σ A} = \frac{1}{σ δ2 π r} , where \qquad ( 1 )$$

σis the conductivity of the conductor, δ is the skin depth, and r is the radius of the conductor. From equation (1) it can be seen that a low-frequency signal penetrates deeper into the conducting material thus having a larger cross-section area and therefore attenuates less than a high-frequency signal.

In known prior art solutions this problem is solved by using equalizers at the receiving end, which equalizers amplify high-frequency components and attenuate low-frequency components.

It is clear that equalization procedure is costly and subject to errors.

### BRIEF DESCRIPTION

It is an object of the present invention to introduce, for signal transmission, a coaxial cable, which offers savings at the signal receiving end, and also a better signal quality.

This is achieved with a coaxial cable for transmitting signals, comprising an inner conductor, said inner conductor comprising a conducting layer for conducting a signal. The conducting layer of the inner conductor has a thickness depending on the skin factor of the highest frequency component contained in signals to be transmitted in the coaxial cable.

The invention also relates to a method for fabricating an inner conductor of a coaxial cable, comprising forming an insulating layer for the inner conductor of a coaxial cable, and forming a conducting layer over said insulating layer.

The invention thus relates to a coaxial cable and the manufacture thereof. The coaxial cable according to the invention can be used for instance in an Internet router, in a computer system, in a base station of a telecommunication network, or in a telecommunication switch. These applications are distinct from each other and each has varying transmission requirements. Therefore the invention is adapted to the application area depending on the application area in question. The invention relates to the transmission of a digital signal using two-level or multi-level logics. Thus the coaxial cable according to the invention can be directly connected to a digital device without any digital-to-analog conversion.

In the invention the inner conductor in a coaxial cable is such that the conducting layer is very thin, about 1 micrometer. In base stations the thickness can vary in the range of 0.2-3.0 micrometers required by the transmission of 1-20 GHz signals. The thickness of the conducting layer is dimensioned the highest frequency components in the signals to be transmitted. Dimensioning is based on the skin or penetration depth of the signal in the metal used in the conducting layer. The higher the frequency of the highest-frequency component is, the thinner is the conducting layer manufactured. The idea in the invention is that when the conducting layer is very thin, also low-frequency components present in the signal will be subject to a similar attenuation as the high-frequency components. The coaxial cable of the invention can be manufactured for example so that the core of an optical fibre is covered with a silver layer. The core of the optical fibre offers a very even surface, which is important in obtaining the best possible quality in signal transmission.

The invention provides a noticeable advantage. When the inner conductor is dimensioned in the way according to the invention, the high-frequency and low-frequency components in the signal will experience the same kind of attenuation and will thus be received having experienced similar distortion conditions. The invention thus improves noticeably the quality of the signal in the form of a smaller degree of inter symbol interference. The invention also reduces the need for attenuation or amplification of signal components in the receiving end.

### DRAWINGS

In the following the invention will be described in greater detail by means of the preferred embodiments with reference to the attached drawings, in which

FIG. 1 shows the skin depth of copper as a function of frequency,

FIG. 2 shows the resistance for two conductors as a function of frequency,

FIG. 3 shows the principal structure of a coaxial cable,

FIG. 4 shows one embodiment of the coaxial cable according to the invention,

FIG. 5 illustrates usage of the coaxial cable, and

FIG. 6 shows one example of the method for manufacturing an inner conductor of a coaxial cable according to the invention.

### EMBODIMENTS

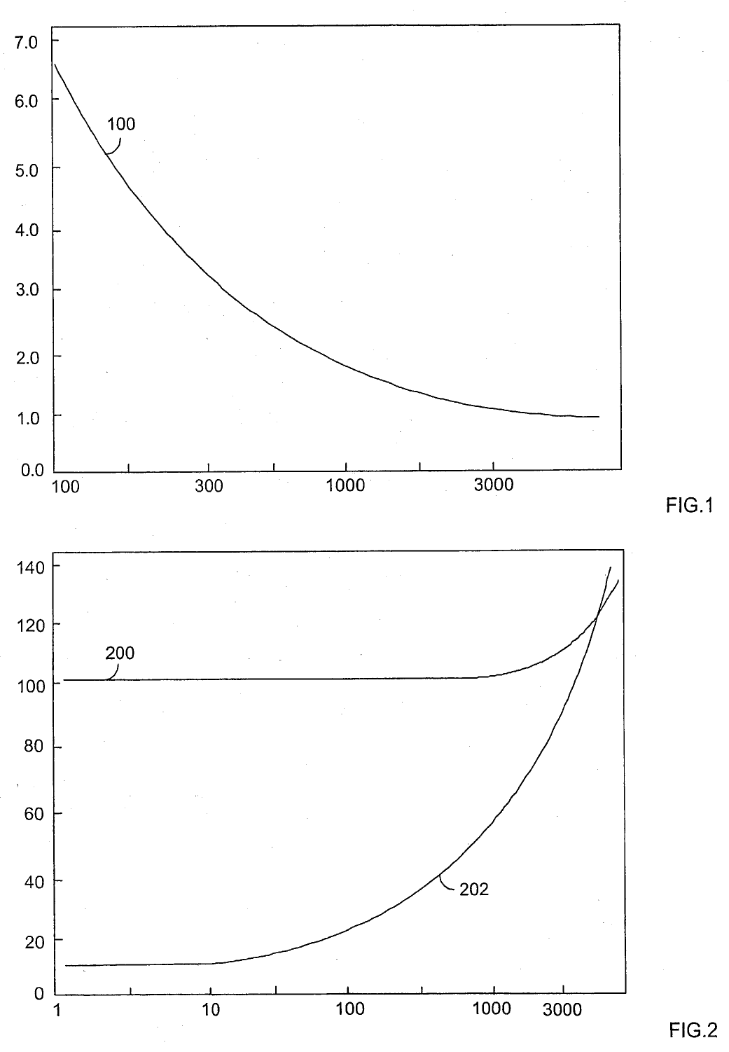

FIG. 1 shows the skin depth of copper as a function 100 of frequency. Skin or penetration depth is linearly dependent on the attenuation coefficient, which describes attenuation of signal energy as a function of distance. For metals the skin depth is very small, as can be seen from FIG. 1, where the x-axis illustrates the frequency of the signal in MHz and the y-axis shows the skin depth in micrometers. It can be seen that for lower frequencies the skin depth is much higher than for higher frequencies. Physically the skin depth δ is defined by equation (2)

$$δ = \frac{1}{\sqrt{π f σ μ}} , where \qquad ( 2 )$$

f means the frequency of the signal, σ is the conductivity of the conductor and μ is the permeability of the conductor.

High-frequency electromagnetic pulses thus traverse only in the outer layer of the conducting material, for instance for a 3 GHz signal the skin depth in copper is only about 1 micrometer. Low-frequency signals penetrate deeper in the conducting material and are not subject to such attenuation than high-frequency signals because the current conducting cross-section is larger than with high frequency signals.

Equation 3 illustrates how the resistance R of the inner conductor depends on the frequency f of the signal and the thickness d of the conductor, the radius r of the conductor, skin depth δ and the conductivity of the conductor σ

$$R ( f , d ) = \frac{1}{σ δ2 π r} [ \frac{sinh ( \frac{2 d}{δ} ) + sin ( \frac{2 d}{δ} )}{cosh ( \frac{2 d}{δ} ) - cos ( \frac{2 d}{δ} )} ] . \qquad ( 3 )$$

Equation (3) shows that the resistance varies inversely proportionally to the radius of the conducting layer. Therefore, by lowering the thickness of the conducting material, the low-frequency signal can be subjected to similar resistance than the high-frequency component in the signal.

FIG. 2 shows the resistance of a one-meter long tubular copper tube. The y-axis illustrates the resistance as a function of the frequency of the signal to be transmitted. Two different thicknesses for the conductor are shown, curve 200 shows the resistance as a function of frequency in a tube having a conductor thickness of 1 micrometer, and curve 202 shows the resistance of a 10-micrometer thick tube. As can be seen, the one-micrometer tube offers almost a constant resistance up to the frequency of 3 GHz, whereas in the tube having a conductor thickness of 10 micrometer, the resistance is strongly dependent on the frequency starting already from frequencies around 30 MHz.

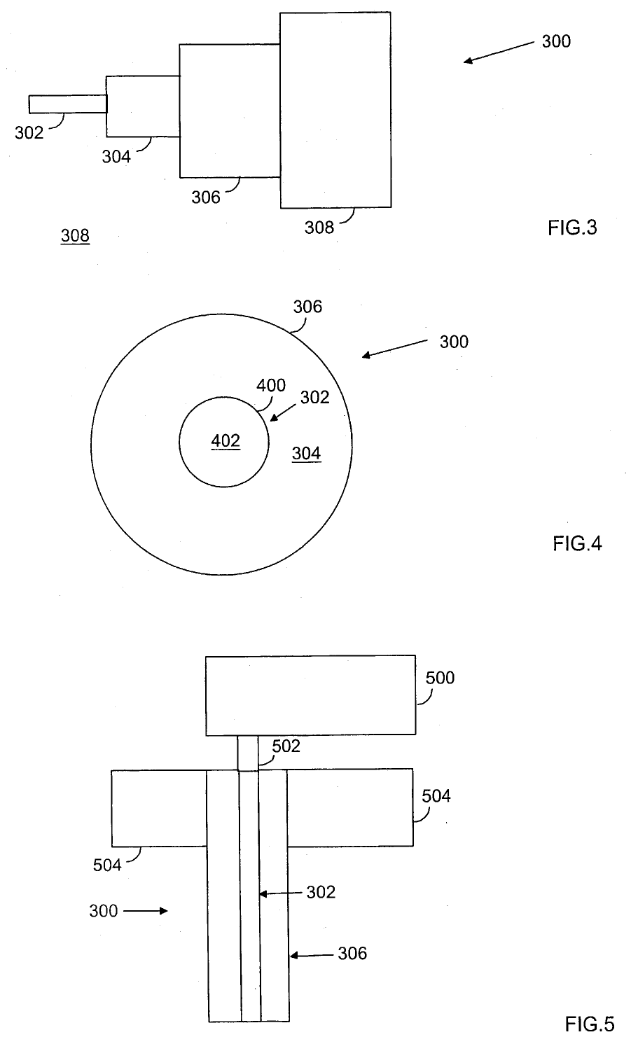

FIG. 3 illustrates the principal structure of a coaxial cable 300. The coaxial cable 300 contains an inner conductor 302, an outer conductor 306 and an insulator between said conductors. The inner conductor 302 carries the signal current and the outer conductor carries the corresponding return current. The return current is formed into the outer conductor due to an electromagnetic field influencing in the insulator 304. The insulator 304 or insulating layer can be for instance air, but practically is often for mechanical reasons some insulating material, such as polyethylene, Teflon or the like. Because the area of the outer conductor 306 is significantly greater than the area of the inner conductor 302, the losses in signal energy during transmission are to a large extent dependent on the properties of the inner conductor 306. FIG. 3 shows also a sheath 308 made for instance of polyethylene for protecting the coaxial cable 300 against wearing.

FIG. 4 shows the cross-section of one embodiment of a coaxial cable according to the invention. The coaxial cable has an outer conductor 306, an insulating layer 304 and an inner conductor as shown also in FIG. 3. The thickness of the outer connector 306 is for instance between 5 and 10 micrometers but can also be less or more. The outer conductor's 306 diameter depends on the transmission requirements. Typically the characteristic impedance of coaxial cables is 50 or 75 ohms. The characteristic impedance depends on the ratio of the outer conductor's 306 diameter compared with the inner conductor's 400 diameter, and on the relative permittivity of the insulation material 304 between them. For example for a one-meter transmission at 10 Gbit/s, the diameter of the outer conductor 306 can be about 200 micrometers. For fulfilling signal transmission requirements in base stations of radio systems, the diameter of the outer connector can vary in the range of 150-500 micrometers. For longer than a one-meter transmission distance, conductor diameters typically have to be larger than mentioned above.

FIG. 4 shows that the inner conductor 302 comprises a conducting layer 400 and an inner space 402 limited by the conducting layer 400. The conducting layer 400 has a thickness that depends on the transmission needs, the frequency of the signal to be transmitted, and the material used as the conducting layer 400. For instance for a 10 Gbit/s and one-meter transmission, the thickness of the conducting layer can be about 1 micrometer. To fulfil the needs in for instance a base station transmission between 1 and 20 Gbits per second, the thickness can vary in the range of 0.2-3.0 micrometers, when silver is used as the conducting material.

Other conducting materials can also be used as the conducting layer, such as copper. For instance also silver coated copper can be used as the conducting layer. Then the added thickness of these two materials is adapted according to the skin depth of the signal. When adapting the thickness of the conducting layer 400 to the signal to be transmitted, a safety margin can be used. That is, the conducting layer can be dimensioned slightly thicker than the skin depth of the highest frequency components present in the signal to be transmitted. The thickness of the conducting layer can also be made thinner than the optimal value determined by the skin depth. In this case the lower amplitude is compensated for with less inter-symbol interference.

The hollow inner space 402 can for mechanical reasons be filled with insulating material. The insulating material can be for instance the core of an optical fibre, that is the light conductor part of an optical cable. Some other material that provides similar properties as the fibre core, that is a durable structure and an extremely even surface, can be used. Evenness of the surface is important for the transmission properties of the inner conductor 302. The diameter of the inner conductor for the previously mentioned transmission need, one meter and 10 GHz, is about 50 micrometers. To fulfil the transmission requirements in base stations, the diameter can vary in the range of 40-100 micrometers. For instance with a diameter of 100 micrometers for the diameter of the inner conductor and a characteristic impedance of 50 ohms, the diameter of the outer conductor is about 500 micrometers. The diameter of the outer conductor depends on the space available; with a larger diameter a larger amplitude for the signal is received but the form of the signal does not depend on the diameter of the outer conductor. The ratio between the diameters of the outer and inner conductor affects the impedance but the absolute values of diameters do not affect the impedance

FIG. 5 illustrates one use of a coaxial cable 300. The coaxial cable is directly connected to the signal from a flip chip device 500. A flip chip device has bonding bumps to connect signals to a support structure like PCB without bonding wires. The connection between the inner conductor 302 of the coaxial cable 300 and the flip chip device is carried out with a bump device 502. The outer connector 306 of the coaxial cable 300 is connected to the ground potential of PCB 504.

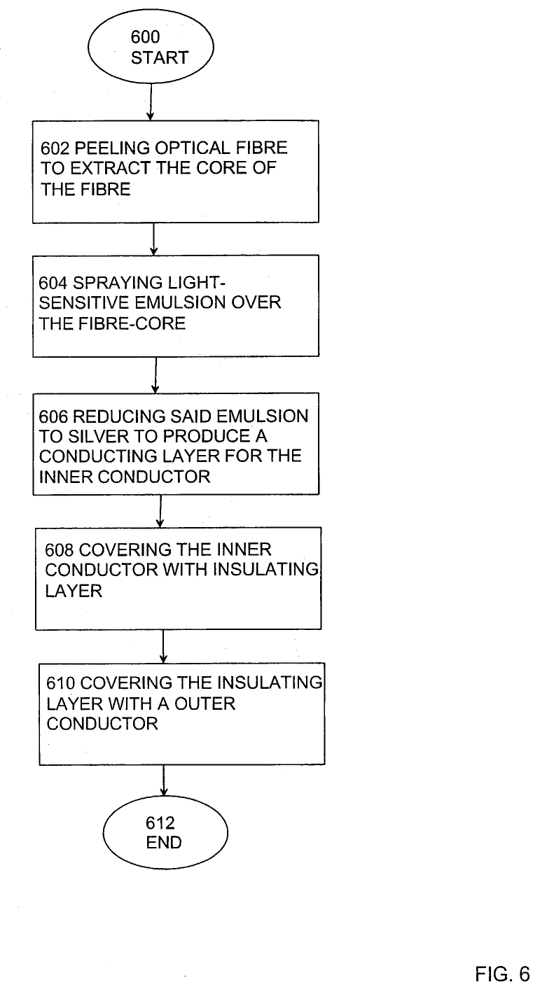

FIG. 6 shows one example of the method for manufacturing a coaxial cable according to the invention. In method stage 602 the insulating material for filling the inner conductor is formed. The contents of the inner conductor can for instance be formed by peeling optical fibre in order to extract the core of the fibre. Then light-sensitive emulsion is sprayed 604 over the core of the fibre. The thickness of the emulsion can be approximately 1 micrometer, varying between 0.2 and 3.0 micrometers. The emulsion is then reduced 606 to form a silver conducting layer for the inner conductor. The steps 604 and 606 describe the use of silver only as an example, but the invention is not restricted to the use of silver. Thus, any known conducting material, such as for instance copper can be used to form the conducting layer of the inner conductor. In step 608 the inner conductor is covered with insulating layer and in step 610 the insulating layer is covered with the outer conductor. The outer conductor can be formed in a similar manner as the inner conductor or some known structure for the outer conductor can be used.

Even though the invention has above been explained with reference to the examples presented in the accompanying drawings, it is apparent that the invention is not restricted thereto but can be modified in various ways within the scope of the inventive idea disclosed in the attached claims.

1. A coaxial cable for transmitting signals, comprising an inner conductor (302), said inner conductor (302) comprising a conducting layer (400) for conducting a signal, characterized in that:
the conducting layer (400) of the inner conductor (302) has a thickness depending on the skin factor of the highest frequency component contained in signals to be transmitted in the coaxial cable (300).

2. A coaxial cable according to claim 1, characterized in that the thickness of the conducting layer increases when the frequency of the highest-frequency component decreases.

3. A coaxial cable according to claim 1, characterized in that the coaxial cable is for transmission of a digital signal.

4. A coaxial cable according to claim 1, characterized in that the inner conductor has a hollow structure, having an outer surface defined by the conducting layer, and an inner space within the conducting layer.

5. A coaxial cable according to claim 4, characterized in that the inner space is filled with insulating material.

6. A coaxial cable according to claim 4, characterized in that the inner space is filled with optical fibre.

7. A coaxial cable according to claim 1, characterized in that the conducting layer is a silver layer.

8. A coaxial cable according to claim 1, characterized in that the conducting layer has a thickness in the range of 0.2-3.0 micrometers.

9. A coaxial cable according to claim 1, characterized in that the inner conductor has a diameter in the range of 40-100 micrometers.

10. A coaxial cable according to claim 1, characterized in that the inner conductor has a diameter in the range of 40-60 micrometers.

11. A coaxial cable according to claim 1, characterized in that the coaxial cable comprises an outer conductor, and the outer conductor has a diameter in the range of 150-500 micrometers.

12. A coaxial cable according to claim 1, characterized in that the coaxial cable is for signal transmission in a base station of a telecommunication network, in an Internet router, a computer system, or in a telecommunications switch.

13. A method for fabricating an inner conductor of a coaxial cable, characterized by:
forming (602) an insulating layer for the inner conductor of a coaxial cable, and
forming (604-606) a conducting layer over said insulating layer.

14. A method according to claim 13, characterized in that the insulating layer is formed by extracting the core from an optical fibre.

15. A method according to claim 13, characterized in that the conducting layer is formed by spraying light-sensitive emulsion over the insulating layer, and by reducing the light-sensitive emulsion to silver for forming the conducting layer of the inner conductor.

16. A method according to claim 13, characterized in that the thickness of the conducting layer is in the range of 0.2-3.0 micrometers.
